(19) United States
(12) Patent Application Publication
(10) Pub. No.: US 2013/0251031 A1
(43) Pub. Date: Sep. 26, 2013

(54) METHOD FOR BIT RATE CONTROL WITHIN A SCALABLE VIDEO CODING SYSTEM AND SYSTEM THEREFOR

(71) Applicants: Yehuda Yitschak, Magen Shaul (IL); Yaniv Klein, Netanya (IL); Erez Steinberg, Tel Aviv (IL)

(72) Inventors: Yehuda Yitschak, Magen Shaul (IL); Yaniv Klein, Netanya (IL); Erez Steinberg, Tel Aviv (IL)

(21) Appl. No.: 13/880,182

(22) PCT Filed: Nov. 25, 2010
(86) PCT No.: PCT/IB10/55413

§ 371 Date: Apr. 18, 2013

(51) Int. Cl. H04N 7/26

(52) U.S. Cl. CPC H04N 19/00424
USPC 375/240.03

(57) ABSTRACT

A method for bit rate control within a scalable video coding system is described. The method comprises, for an access unit within a scalable encoded video bit stream, determining a bit budget for at least one spatial dependence layer within the scalable encoded video bit stream, and calculating at least one quantization parameter value for encoding the at least one spatial dependence layer based at least partly on the determined bit budget for the at least one spatial dependence layer.

### FIELD OF THE INVENTION

This invention relates to a method for bit rate control, and in particular to a method for bit rate control within a scalable video coding system.

### BACKGROUND OF THE INVENTION

The Advanced Video Coding (AVC) standard, otherwise known as H.264/MPEG-4 Part 10, is a well known video compression standard developed by the ITU-T (Telecommunication Standardization Sector for the International Telecommunication Union) Video Coding Experts Group (VCEG) together with the Moving Picture Experts Group (MPEG). H.264/MPEG-4 Part 10 comprises advanced compression techniques that were developed to enabled transmission of video signals at a lower bit rate or to enable improved video quality at a given transmission rate.

The continuous evolution of receiving devices and the increasing usage of transmission systems that are characterised by a widely varying connection quality has led to the desire for scalable video coding, which allows on-the-fly adaptation to certain application requirements such as display and processing capabilities of target device, and varying transmission conditions. In particular, video coding is increasingly being used within a wide range of applications ranging from wireless/mobile applications such as multimedia messaging, video telephony, video conferencing and video streaming, to standard and high definition television broadcasting. Furthermore, as the Internet and wireless networks become increasingly important for the transmission of video content, such video transmissions are becoming increasingly exposed to widely varying transmission conditions, and to widely varying decoding devices with varying display and computational capabilities.

Scalable Video Coding (SVC) is an extension of the H.264/MPEG-4 Part 10 video compression standard (Annex G) that provides a network-friendly scalability at a bit stream level. In particular, SVC supports functionalities such as bit rate, format and power adaptation, graceful degradation in lossy transmission environments as well as lossless rewriting of quality scalable SVC bit streams to single-layer H.264/MPEG-4 Part 10 bit streams. The scalable bit streams provided by way of SVC encoding comprise one or more sub-streams that can be extracted in a way that a resulting sub-stream forms another valid bit stream for some target decoder. The usual modes of scalability are temporal, spatial and quality scalability. Spatial scalability and temporal scalability describe cases in which subsets of the bit stream represent the source content with a reduced picture size (spatial scalability) and/or a reduced frame rate (temporal resolution) respectively. With quality scalability, the sub-stream provides the same spatio-temporal resolution as its associated complete bit-stream, but with a lower fidelity, where fidelity is often informally referred to as signal-to-noise ratio (SNR). Quality scalability is also commonly referred to as fidelity scalability or SNR scalability. Other, less commonly required scalability modes include region-of interest (ROI) and object-based scalability, in which the sub-streams typically represent spatially contiguous regions of the original picture area. The different types of scalability may also be combined so that a multitude of representations with different spatio-temporal resolutions and bit rates can be supported within a single scalable bit stream.

For AVC implementations, it is known for rate control to be used to regulate the output bit rate of an encoded video system, for example in accordance with a transmission channel bandwidth. When such rate control is applied in an encoder, a quantization parameter (QP) for the video information encoding is adjusted in order to maintain a target bit rate for the output bit stream. Whilst conventional techniques for providing such rate control are adequate for AVC implementations in which only a single overall channel bandwidth needs to be taken into consideration, they typically are not suitable for SVC implementations in which multiple bandwidth restrictions may need to be taken into consideration. Specifically, each sub-stream within a bit stream output by an SVC encoder may be required to meet specific bandwidth and/or target device specifications, and as such may be required to be limited to a specific bit rate.

### SUMMARY OF THE INVENTION

The present invention provides a method for bit rate control within a scalable video coding system, a scalable video coding system and an integrated circuit device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates an example of a scalable video encoding system.

FIG. 2 illustrates a simplified example of a transmission network.

FIGS. 3 and 4 illustrate a simplified example of temporal, spatial and quality scalability.

FIG. 5 illustrates a simplified flowchart of a method for rate control within a scalable video coding system.

### DETAILED DESCRIPTION OF THE PREFERRED EMBODIMENTS

The present invention will now be described with reference to a scalable video encoding system arranged to provide temporal, spatial and quality scalability within an encoded video bit stream, such as may be implemented in accordance with Annex G of the H.264/MPEG-4 Part 10 video compression standard. However, it will be appreciated that the present invention is not limited solely to use with such a scalable video encoding system, and may equally be applied within alternative scalable video encoding implementations.

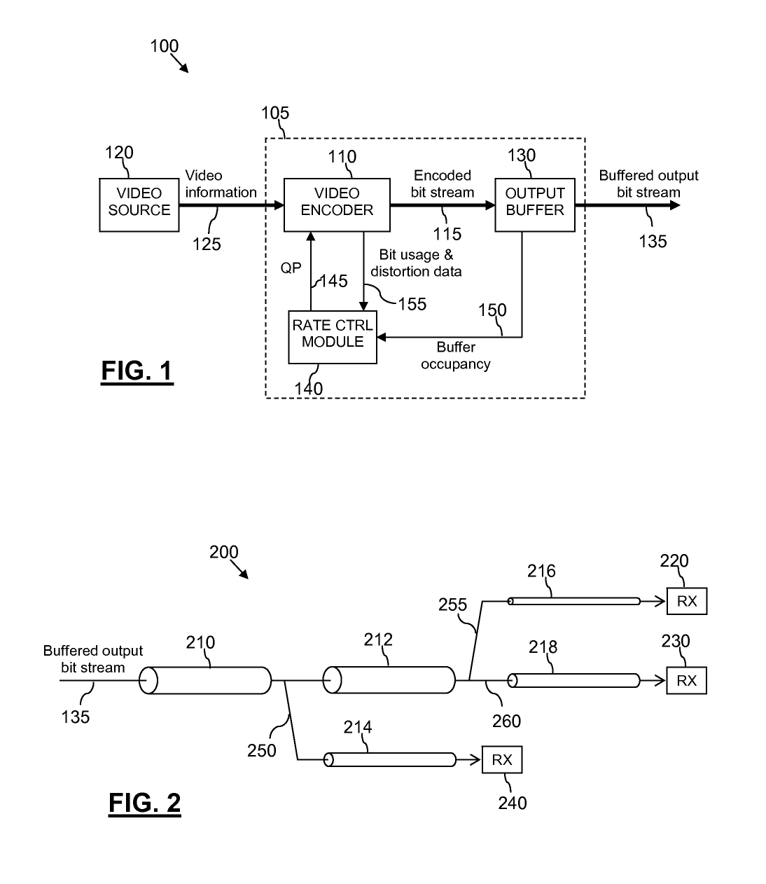

Referring first to FIG. 1, there is illustrated an example of a scalable video encoding system 100 adapted in accordance with some exemplary embodiments of the present invention. It is contemplated that some or all of the scalable video encoding system 100 may be implemented within one or more integrated circuit device(s), as illustrated generally at 105. For example, the various functional components hereinafter described may be implemented by way of one or more application specific integrated circuit (ASIC) devices, or by way or one or more programmable digital signal processor(s) (DSP(s)) and/or microcontroller(s). Additionally/alternatively, some or all of the scalable video encoding system 100 may be implemented by way of program code arranged to execute on one or more signal processor(s) (not shown).

For the illustrated example, the scalable video encoding system 100 comprises a video encoder module 110 arranged to receive video information 125 from a video source 120, encode the received video information 125, and to output a scalable encoded video bit stream 115. For the example illustrated in FIG. 1, the scalable video encoding system 100 further comprises an output buffer 130 arranged to receive the scalable encoded video bit stream 115 output by the video encoder module 110, and to buffer the scalable encoded video bit stream 115 for transmission over a transmission channel 210 (FIG. 2) as a buffered output bit stream 135. Although for the illustrated example, the output buffer 130 is illustrated as forming an integrated part of the scalable encoding system 100, it will be appreciated that the output buffer 130 may equally be implemented as a discrete component to which an output of the scalable video encoding system 100 is operably coupled.

FIG. 2 illustrates a simplified example of a transmission network 200 via which encoded video information output by the scalable video encoding system 100 may be distributed to various different target devices 220, 230, 240. The transmission network 200 operably couples the output buffer 130 of the scalable video encoding system 100 to the target devices 220, 230, 240 by way of various transmission channels, as illustrated generally at 210, 212, 214, 216, and 218. Such transmission channels may comprise any suitable means of conveying the encoded video information, for example electrically using copper wires, optically using optical fibres, wirelessly using radio frequency communication channels, etc. Such a transmission network typically comprises various routers, exchanges, etc. (not shown).

As will be appreciated by a skilled artisan, the available data rate for the buffered output bit stream 135 is dependent on the bandwidth of the transmission channel over which the buffered output bit stream 135 is transmitted. In particular, for the example illustrated in FIG. 2, the available data rate for the buffered output bit stream 135 will be dependent on the bandwidth of the transmission channel 210 to which the output buffer 135 is operably coupled. If the bit rate of the scalable encoded video bit stream 115 output by the video encoder module 110 exceeds the available data rate for the buffered output bit stream 135 (i.e. exceeds the available bandwidth of the transmission channel 210 for the illustrated example), the amount of encoded video data buffered within the output buffer 130 will increase until the output buffer 130 becomes full and ‘overflows’, whereupon encoded video data will be lost. In order to avoid the output buffer 130 from overflowing, it is necessary to control the bit rate of the scalable encoded video bit stream 115 output by the video encoder module 110 such that it does not exceed the available data rate for the buffered output bit stream 135 (at least not for prolonged periods of time).

Accordingly, for conventional (non-scalable) H.264/MPEG-4 Part 10 video encoding systems, it is known for rate control to be used to regulate the output bit rate of the video encoding system in accordance with the transmission channel bandwidth, whereby a quantization parameter (QP) for the video information encoding is adjusted in order to maintain a target bit rate for the output bit stream. The quantization parameter determines the quantization step which is used to quantize the residual signal of motion prediction during encoding. The lower the quantization step, the more information is provided to a target encoder and thus a higher quality signal is achieved, but at the expense of a higher bit rate. Accordingly, the scalable video encoding system 100 of FIG. 1 further comprises a rate control module 140, arranged to provide a QP value to the video encoder module 110, and to adjust the QP value 145 in order to maintain a target bit rate for the scalable encoded video bit stream 115.

Whilst conventional techniques for providing such rate control are adequate for conventional (non-scalable) video encoding systems in which only a single overall channel bandwidth needs to be taken into consideration, they typically are not suitable for scalable video encoding systems in which multiple bandwidth restrictions may need to be taken into consideration. For example, and referring back to FIG. 2, in a scalable video encoding system, the scalable encoded video stream comprises one or more sub-streams that can be extracted in a way that a resulting sub-stream forms another valid bit stream for some target decoder. For example, as illustrated generally at 250 and 255, a sub-stream may be extracted in order to meet specific transmission channel and/or target device limitations/requirements. Similarly, the scalable encoded video stream may be ‘thinned’, as illustrated generally at 260, again in order to meet specific transmission channel and/or target device limitations/requirements. Specifically, each sub-stream within a bit stream output by a scalable video encoding system may be required to meet specific bandwidth and/or target device specifications, and as such may be required to be limited to a specific bit rate. Accordingly, it is desirable for rate control to be provided not just for the overall scalable encoded video bit stream 115, but also at a lower level for individual sub-streams within the overall scalable encoded video bit stream 115.

The usual modes of scalability are temporal, spatial and quality scalability. Spatial scalability and temporal scalability describe cases in which subsets of the bit stream represent the source content with a reduced picture size (spatial scalability) and/or a reduced frame rate (temporal resolution) respectively. With quality scalability, the sub-stream provides the same spatio-temporal resolution as an associated (higher-level) bit-stream, but with a lower fidelity, where fidelity is often informally referred to as signal-to-noise ratio (SNR). Quality scalability is also commonly referred to as fidelity scalability or SNR scalability. Other, less commonly required scalability modes include region-of interest (ROI) and object-based scalability, in which the sub-streams typically represent spatially contiguous regions of the original picture area. The different types of scalability may also be combined so that a multitude of representations with different spatio-temporal resolutions and bit rates can be supported within a single scalable bit stream.

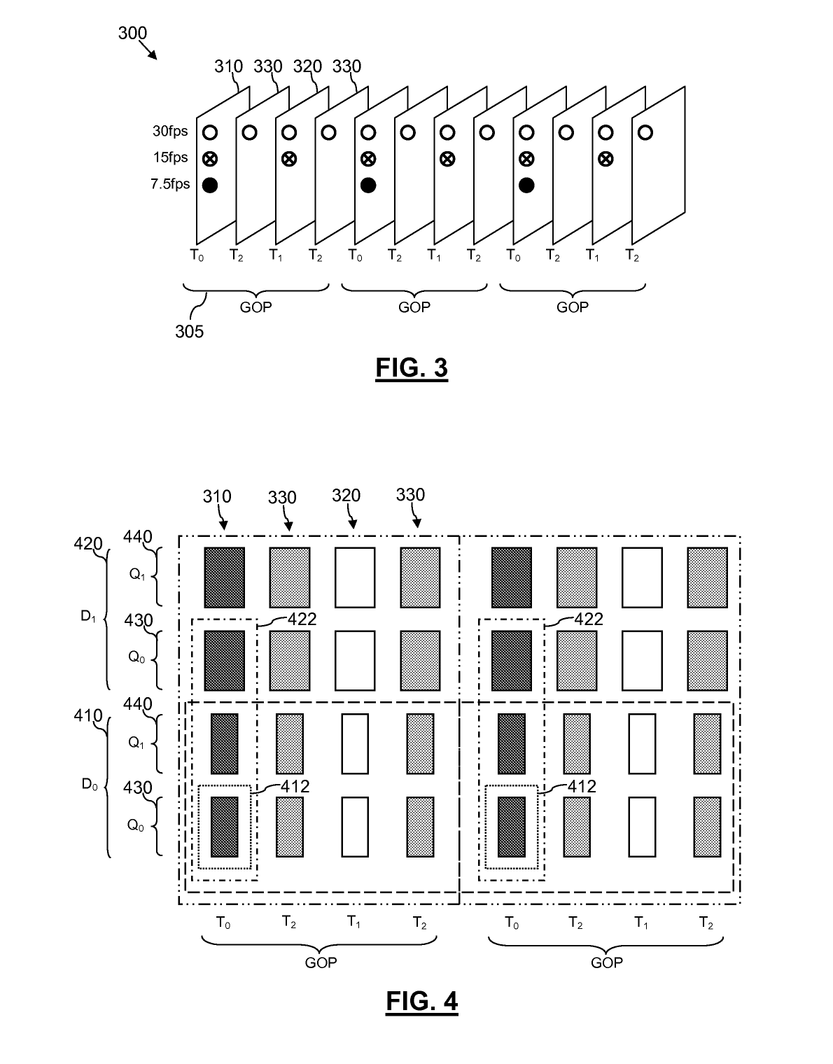

Referring to FIG. 3, there is illustrated a simplified example of temporal scalability such as implemented in accordance with Annex G of the H.264/MPEG-4 Part 10 video compression standard. A bit stream provides temporal scalability when a set of corresponding ‘access units’ (illustrated generally at 300) can be partitioned into a temporal base layer and one or more temporal enhancement layers. For the illustrated example, each set of access units comprises a ‘Group Of Pictures’ (GOP) 305 made up of first access unit T₀ 310 forming the temporal base layer for the GOP 305, and three further access units forming temporal enhancement layers, and specifically access unit T₁ 320 forming a first temporal enhancement layer, and access units T₂ 330 forming a second temporal enhancement layer. Thus, the temporal base layer (provided by access unit T₀ 310 within each GOP 305) provides a video signal comprising a frame rate of 7.5 fps. The first temporal enhancement layer (provided by access unit T₁ 320 within each GOP) enhances the temporal base layer to provide a video signal comprising a frame rate of 15 fps. The second enhancement layer (provided by access units T₂ 330 within each GOP 305) enhances the temporal base and first enhancement layers to provide a video signal comprising a frame rate of 30 fps. In this manner, by extracting the appropriate access units 310, 320, 330, the frame rate of the video signal may be scaled between 7.5, 15 and 30 frames per second.

For scalable video compression implemented in accordance with Annex G of the H.264/MPEG-4 Part 10 video compression standard, spatial and quality scalability is implemented within each access unit, as illustrated in FIG. 4. Each access unit 310, 320, 330 comprises a spatial dependence base layer D₀, as illustrated generally at 410, and may comprise one or more spatial dependence enhancement layers, such as the spatial dependence enhancement layer D₁ illustrated generally at 420. In this manner, the spatial dependence base layer D₀ 410 provides a video signal comprising a low resolution (e.g. small picture size), with the spatial dependence enhancement layer D₁ 420 ‘enhancing’ the spatial dependence base layer D₀ 410 to provide a video signal comprising a higher resolution (e.g. increased picture size). Similarly, each spatial dependence layer 410, 420 comprises a quality base layer Q₀, as illustrated generally at 430, and may comprise one or more quality enhancement layers, such as the quality enhancement layer Q₁ illustrated generally at 440. In this manner, the quality base layer Q₀ 430 provides a video signal comprising a low quality (e.g. low fidelity), with the quality enhancement layer Q₁ 440 ‘enhancing’ the quality base layer Q₀ 430 to provide a video signal comprising a higher quality (e.g. increased fidelity).

Referring back to FIG. 1, the video encoder module 110 is arranged to encode the received video information 125 to generate the scalable encoded video bit stream 115 such that the scalable video encoded bit stream 115 comprises access units, such as the access units 310, 320, 330 illustrated in FIGS. 3 and 4, whereby each access unit comprises one or more spatial dependence layers, such as the spatial dependence layers 410, 420 illustrated in FIG. 4. In this manner, the scalable encoded video bit stream 115 is at least capable of spatial scalability, such that one or more sub-streams corresponding to determined spatial resolutions may be extracted from the scalable video encoded bit stream 115.

The rate control module 140 is further arranged, for each access unit (such as the access units 310, 320, 330) within the scalable encoded video bit stream 115 output by the video encoder module 110 to determine bit budgets for the one or more spatial dependence layers within the scalable encoded video bit stream 115 (such as the spatial dependence layers 410, 420), and to calculate quantization parameter (QP) values 145 for encoding the spatial dependence layers based at least partly on the determined bit budgets therefor. By separately determining bit budgets at the spatial dependence layer level (as opposed to determining an overall bit budget for, say, each set of access units, such as each GOP 305), QP values may also be calculated at the spatial dependence layer level, allowing the QP values provided to the video encoder module to be individually adapted for the different spatial dependence layers within each access unit. In this manner, rate control is able to be provided not just for the overall scalable encoded video bit stream 115, but also at a lower level for individual sub-streams within the overall scalable encoded video bit stream 115 at an individual spatio-temporal resolution.

In accordance with some examples of the present invention, the rate control module 140 is arranged, for each spatial dependence layer, to calculate QP values for encoding a quality base layer (such as quality base layer 430) and zero of more quality enhancement layer (such as quality enhancement layer 440). For example, the QP values for the quality layers within a spatial dependence layer may be calculated based on, say, a defined distribution of the determined bit budget for that spatial dependence layer.

In accordance with some examples of the present invention, it is contemplated that the bit budget for each spatial dependence layer may be determined based on, say, a weighted average of two factors: a buffer occupancy for the output buffer 130 at the start of encoding the respective access unit; and the remaining bit budget of, say, the GOP 305 of which the respective spatial dependence layer forms a part. Accordingly, for the illustrated example, the rate control module 140 is arranged to receive buffer occupancy information 150 from the output buffer 130. With regard the remaining bit budget for a GOP 305, it is contemplated that the available bit budget for a GOP may not be distributed evenly among temporal layers therein. For example, lower temporal layers (e.g. access unit T₀ 310 within each GOP 305) may receive a larger proportion of the GOP bit budget since they are referenced by more frames than higher temporal layer (e.g. access units T₂ 330 within each GOP 305). The distribution of the bit budget may be based on a weighting table which may be fixed or dynamically adapted. One example of a formula for determining the bit budget allocation for each access unit comprises:

bitBudget(T_{id})=RemainGopBudget*weight(T_{id})/RemainWeight [Eq. 1]

The “RemainWeight” is set to 1 at the GOP start. It is then reduced by the weight of the current temporal layer after completion of each AU. For example using 3 temporal layers as illustrated in the illustrated examples, the weights may be set to, say, 0.5 for T₀, 0.3 for T₁ and 0.1 for T₂. In this manner, when determining the budget for access unit T₀ 310 at the start of a GOP:

RemainGopBudget=BB_{GOP};

weight(T_{id})=0.5; and

RemainWeight=1.

Accordingly, this first access unit T₀ 310 at the start of a GOP will receive a bit budget of:

BB_{GOP}*0.5/1=BB_{GOP}/2.

Following the encoding of the first access unit T₀ 310, the remaining bit budget for the next access unit within the GOP after encoding access unit T₀ 310 at the start of the GOP will equal (BB_{GOP}−BitUsageT₀), and the remaining weight will equal (1-0.5)=0.5.

For the illustrated example, the next access unit to be encoded comprises the first access unit T₂ 330 within the GOP 305. Accordingly, this access unit receives (BB_{GOP}−BitUsageT₀)*0.1/0.5). The remaining bit budget for the GOP after encoding the first access unit T₂ 330 within the GOP 305 will be (BB_{GOP}−(BitUsage_T₀+BitUsage_T₂), and the remaining weight will equal 0.4.

The next access unit to be encoded for the illustrated example comprises the access unit T₁ 320 within the GOP 305. Accordingly, this access unit receives ((BB_{GOP}−(BitUsage_T₀+BitUsage_T₂))*0.3/0.4). The remaining bit budget for the GOP after encoding the access unit T₁ 320 within the GOP 305 will be (BB_{GOP}−(BitUsage_T₀ +BitUsage_T₂+BitUsage_T₁), and the remaining weight will equal 0.1.

The final access unit to be encoded comprises the second access unit T₂ 330 within the GOP 305. Accordingly, this access unit receives ((BB_{GOP}−(BitUsage_T₀+BitUsage_T₂+BitUsage_T₁)*0.1/0.1).

An important factor that effects the number of data bits required to encode an image, and thereby the bit rate for the encoded video stream, is the encoding complexity, and specifically where prediction coding is implemented the coding complexity of the residuals that are left over after the inter or intra prediction process is finished (inter/intra layer distortion). Accordingly, the data rate for the scalable encoded video bit stream 115 may more accurately be controlled if such distortion is also taken into consideration when calculating the QP values. The Mean Absolute Difference (MAD) of prediction error is typically closely related to encoding complexity, and as such may be used to estimate the inter layer distortion, for example using a linear regression method. Thus, for some example embodiments of the present invention, the rate control module 140 may be arranged to estimate such inter layer distortion for individual spatial dependence layers, and to calculate the respective QP values for encoding the spatial dependence layers based on the determined bit budget and the estimated distortion therefor.

QP values may be calculated using one or more R-Q (Rate-Quantization) models. For example, the QP value for, say, the quality base layer within a spatial dependence layer may be calculated using the following quadratic R-Q equation:

bits/distortion=const₁*Qstep²+const₂*Qstep [Eq. 2]

where Qstep is the quantization step used during encoding. It is contemplated that an alternative R-Q model may be used to calculate the QP value for the quality enhancement layer, for example a model that connects the bit rate and QP of the corresponding quality base layer with the bit rate and QP of the quality enhancement layer.

In accordance with some examples of the present invention, the rate control module 140 may be arranged, prior to the video encoder module 110 encoding an access unit, to determine bit budgets (and distortion estimates) for the spatial dependence layers within the access unit, and to calculate initial QP values for encoding the spatial dependence layers based thereon. The rate control module 140 may subsequently, during encoding of the access unit, calculate revised QP values for encoding the spatial dependence layers based on intra layer distortion. For example, the rate control module 140 may be arranged, during encoding of an access unit, to calculate a revised QP value for a spatial dependence layer on a row by row basis for the image (frame) of the spatial dependence layer. Since the distortion of individual rows within the image will vary, highly distorted rows will use a greater proportion of the bit budget than less distorted rows. Accordingly, by estimating the distortion of an individual row, and calculating a revised QP value for that row taking into account the estimated distortion therefor, the bit rate for encoding that row within the spatial dependence layer may be more accurately controlled. In addition, it is contemplated that such revised QP values may further be based on prior bit budget consumption during the encoding of the respective spatial dependence layer, in order to more accurately control the overall bit rate therefor.

In accordance with some example embodiments of the present invention, the rate control module 140 may further be arranged to collect encoding data in order to update the R-Q models and or distortion prediction models used in calculating the QP values. For example, the rate control module 140 may be arranged to collect, say, actual bit usage data (i.e. the actual number of bits used to encode, say, an access unit) and actual distortion data resulting from encoding, say, an access unit, and use the collect bit usage data and distortion data to update the R-Q models used to calculate the QP values and/or the linear regression models used to estimate inter/intra layer distortion. Accordingly, for the illustrated example, the rate control module 140 is arranged to receive such bit usage date 155. In this manner, the various models etc. used in the calculation of the QP values may be dynamically updated using actual usage data in order to continuously calibrate the rate control for the scalable video coding system 100, thereby enabling the bit rate of the resulting scalable encoded video bit stream 115 to be substantially optimized.

Advantageously, the rate control module 140 of the illustrated example enables bit rate points to be defined for the scalable encoding of video information. For example, and referring back to FIG. 4, a minimum rate point may be defined for each spatial dependency layer 410, 420, whereby the minimum rate point for a spatial dependency layer comprises only the base quality and base temporal layers therefor. So, a minimum rate point (illustrated at 412) for the spatial dependency base layer 410 comprises the quality base layer 430 therefor within the first access unit T₀ 310 forming the temporal base layer for each GOP 305. Similarly, a minimum rate point (illustrated at 422) for the spatial dependency enhancement layer 420 comprises the quality base layers 430 for the spatial dependency enhancement layer 420 and the spatial dependency base layer 410 within the first access unit T₀ 310 forming the temporal base layer for each GOP 305. In this manner, for each spatial dependency layer a minimum (i.e. worst case) rate point may be defined.

Further rate points may also be defined for each spatial dependency layer, such a maximum rate points 414, 424 illustrated in FIG. 4, whereby the maximum rate point for a spatial dependency layer comprises all (i.e. base and each enhancement) quality and temporal layers therefor. In this manner, for each spatial dependency layer a maximum (i.e. best case) rate point may be defined.

The ability to define such rates points for individual spatial dependency layers enables end-users/applications to more accurately/appropriately select a suitable sub-stream based on configuration information provided by the video stream provider.

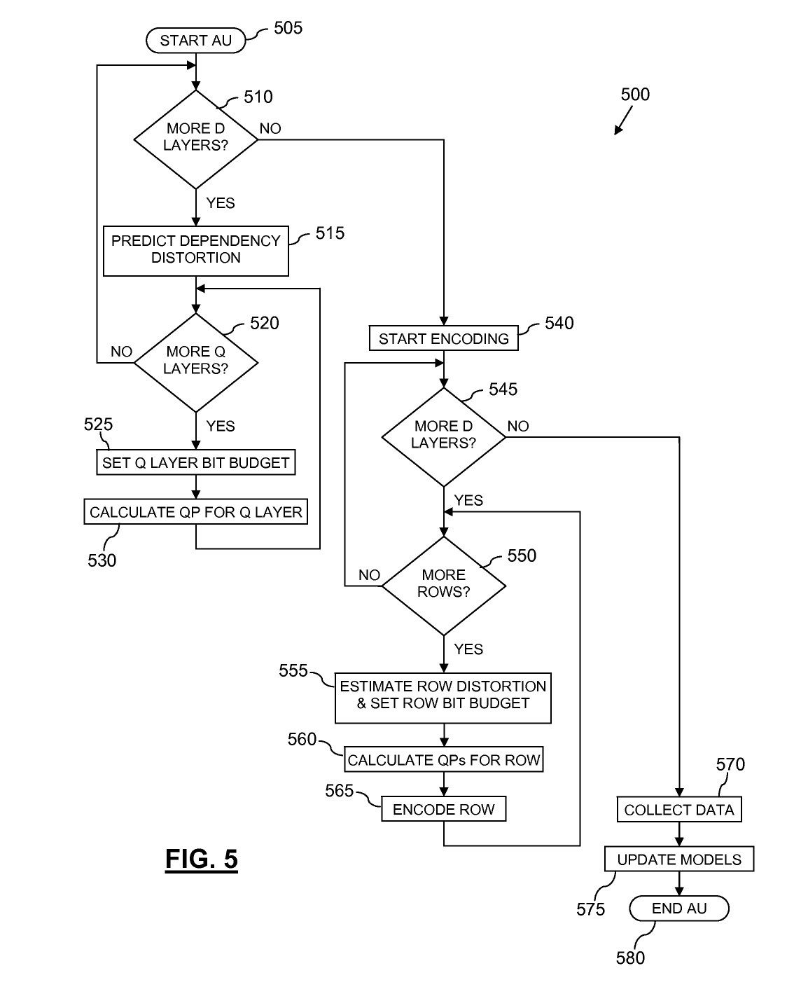

Referring now to FIG. 5, there is illustrated a simplified flowchart 500 of an example of a method for bit rate control within a scalable video coding system according to some embodiments of the present invention, such as may be implemented within the rate control module 140 of FIG. 1. The method starts at step 505 with the start of an access unit (AU) to be encoded, and moves on to steps 510 to 530, which for the illustrated example are performed prior to encoding being commenced for the current access unit.

At step 510 it is determined whether there are more spatial dependence layers to be processed. If it is determined that there are more spatial dependence layers to be processed the method moves on to step 515, where dependency distortion is estimated for the current (e.g. first) spatial dependence layer, for example based on a mean absolute difference (MAD) prediction. The method then moves on to step 520, where it is determined whether there are more quality layers for which quantization parameter (QP) values are to be calculated. If it is determined that there are more quality layers to be processed, the method moves on to step 525 where a bit budget is set for the current (e.g. first) quality layer of the current spatial dependence layer. For example, a bit budget for each spatial dependence layer may be determined based on, say, a weighted average of two factors: a buffer occupancy for the output buffer at the start of encoding the respective access unit; and the remaining bit budget of the preceding, say, 8 access units. The bit budget for the current quality layer may then be determined based on, for example, a defined distribution of the determined bit budget for that spatial dependence layer. Next, at step 530, a QP value for the current quality layer is calculated, for example based on the determined bit budget and distortion estimation. The method then loops back to step 520, where it is determined whether there are more quality layers for which QP values are to be calculated. In this manner, the method calculates a QP value for each quality layer within the current spatial dependence layer. Once QP values have been calculated for all quality layers within the current spatial dependence layer (i.e. it is determined that there are no more quality layers for which QP values are to be calculated at step 520), the method loops back to step 510, where it is determined whether there are more spatial dependence layers to be processed. In this manner, the method calculates QP values for the quality layers of all spatial dependence layers within the current access unit. Once QP values have been calculated for the quality layers of all the spatial dependence layers (i.e. it is determined that there are no more spatial dependence layers to be processed within step 510) the method moves on to step 540 where encoding of the current access unit is commenced. The method then moves on to steps 545 to 565, which for the illustrated example are performed during encoding of the current access unit.

At step 545 it is determined whether there are more spatial dependence layers to be encoded. If it is determined that there are more spatial dependence layers to be encoded the method moves on to step 550 where, for the illustrated example, it is determined whether there are more rows within the image (frame) of the current spatial dependence layer to be encoded. If it is determined that there are more rows of the current spatial dependence layer to be encoded, the method moves on to step 555, where the row distortion is estimated and a bit budget is set for the current row, for example as described above with reference to FIG. 1. Next, at step 560, revised QP values for the current row within each quality layer of the current spatial dependence layer are calculated. The row is then encoded at step 565, and the method loops back to step 550, where it is determined whether there are more rows within the current spatial dependence layers to be encoded. In this manner, the method encodes each row of the current spatial dependence layer, and within all quality layers therein, using revised QP values for each row of the current spatial dependence layer. Once all the rows within the current spatial dependence layer have been encoded (i.e. it is determined that there are no more rows within the current spatial dependence layer to be encoded within step 550) the method loops back to step 545, where it is determined whether there are more spatial dependence layers to be encoded. In this manner, the method encodes all spatial dependence layers within the current access unit using revised QP values. Once all the spatial dependence layers have been encoded (i.e. it is determined that there are no more spatial dependence layer to be encoded within step 545) the method moves on to step 570, where data such as actual bit usage data and/or distortion data is collected. The models used in calculating the (revised) QP values (e.g. R-Q models and distortion prediction models) are then updated using the collected data at step 575. The method then ends at step 580 with the end of the current access unit.

In accordance with some example embodiments, each QP value may be bounded to within a maximum distance from the QP of the same layer in the previous AU. In this manner, large fluctuations in quality between successive frames and large quality fluctuations inside the frame itself may be substantially avoided. For example, each QP may be bound by the formula:

newQP=MIN(prevQP+DeltaQP, MAX(prevQP−deltaQP, newQP)) [Eq. 3]

Such QP cropping may occur every time a QP value is calculated, whether on an image/layer level (e.g. prior to encoding for the illustrated example, or on a row level (e.g. during encoding for the illustrated example). In addition, in some examples, the DeltaQP value may be varied between access units within a GOP, depending on the coding conditions, in order to adapt the bounding of the QP for each access unit accordingly.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

As previously mentioned, the invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, for clarity and ease of description, the rate control module 140 has been illustrated as comprising a discrete component within the scalable video encoding system 100 of FIG. 1. However, it will be appreciated that a rate control module adapted in accordance with example embodiments of the present invention may equally form an integral part of, say, a video coding module, such as the video coding module 110 illustrated in FIG. 1.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also the illustrated examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method for bit rate control within a scalable video coding system, for an access unit within a scalable encoded video bit stream, the method for comprising:
determining a bit budget for at least one spatial dependence layer within the scalable encoded video bit stream; and
calculating at least one quantization parameter (QP) value for encoding the at least one spatial dependence layer based at least partly on the determined bit budget for the at least one spatial dependence layer.

2. The method of claim 1 wherein the method comprises calculating, based at least partly on the determined bit budget for the at least one spatial dependence layer:
a QP value for encoding a quality base layer of the at least one spatial dependence layer; and
at least one QP value for encoding at least one quality enhancement layer of the at least one spatial dependence layer.

3. The method of claim 1 wherein the method further comprises estimating inter layer distortion for the at least one spatial dependence layer, and calculating the at least one QP value for encoding the at least one spatial dependence layer based at least partly on the determined bit budget and estimated distortion for the at least one spatial dependence layer.

4. The method of claim 1 wherein the method comprises calculating the at least one QP value using at least one R-Q (Rate-Quantization) model.

5. The method of claim 1 wherein the method comprises, prior to encoding an access unit within the scalable encoded video bit stream:
determining a bit budget for at least one spatial dependence layer within the access unit; and
calculating at least one initial QP value for encoding the at least one spatial dependence layer based at least partly on the determined bit budget for the at least one spatial dependence layer,
wherein the method further comprising, during encoding of the access unit:
calculating at least one revised QP value for encoding the at least one spatial dependence layer based at least partly on intra layer distortion.

6. The method of claim 5 wherein the method comprises, during encoding of the access unit calculating the at least one revised QP value on a row by row basis within an image of the at least one spatial dependence layer.

7. The method of claim 6 wherein the at least one revised QP value is calculated based further on prior bit budget consumption during the encoding of the at least one spatial dependence layer.

8. The method of claim 1 wherein the method further comprises collecting at least one from a group of bit usage data and distortion data, and using such collected data to update at least one from a group of:
at least one R-Q (Rate-Quantization) model used for calculating QP values; and
at least one distortion prediction model used for estimating inter/intra layer distortion.

9. A scalable video coding system comprising:
a rate control module arranged, for an access unit within a scalable encoded video bit stream output by the video coding system, to determine a bit budget for at least one spatial dependence layer within the scalable encoded video bit stream and to calculate at least one quantization parameter value for encoding the at least one spatial dependence layer based at least partly on the determined bit budget for the at least one spatial dependence layer.

10. An integrated circuit device comprising:
a rate control module arranged, for an access unit within a scalable encoded video bit stream output by a video coding system, to determine a bit budget for at least one spatial dependence layer within the scalable encoded video bit stream to to calculate at least one quantization parameter value for encoding the at least one spatial dependence layer based at least partly on the determined bit budget for the at least one spatial dependence layer.

11. The method of claim 2 wherein the method further comprises estimating inter layer distortion for the at least one spatial dependence layer, and calculating the at least one QP value for encoding the at least one spatial dependence layer based at least partly on the determined bit budget and estimated distortion for the at least one spatial dependence layer.

12. The method of claim 2 wherein the method comprises calculating the at least one QP value using at least one R-Q (Rate-Quantization) model.

13. The method of claim 3 wherein the method comprises calculating the at least one QP value using at least one R-Q (Rate-Quantization) model.

14. The method of claim 2 wherein the method comprises, prior to encoding an access unit within the scalable encoded video bit stream:
determining a bit budget for at least one spatial dependence layer within the access unit; and
calculating at least one initial QP value for encoding the at least one spatial dependence layer based at least partly on the determined bit budget for the at least one spatial dependence layer,
wherein the method further comprising, during encoding of the access unit:
calculating at least one revised QP value for encoding the at least one spatial dependence layer based at least partly on intra layer distortion.

15. The method of claim 3 wherein the method comprises, prior to encoding an access unit within the scalable encoded video bit stream:
determining a bit budget for at least one spatial dependence layer within the access unit; and
calculating at least one initial QP value for encoding the at least one spatial dependence layer based at least partly on the determined bit budget for the at least one spatial dependence layer,
wherein the method further comprising, during encoding of the access unit:
calculating at least one revised QP value for encoding the at least one spatial dependence layer based at least partly on intra layer distortion.

16. The method of claim 4 wherein the method comprises, prior to encoding an access unit within the scalable encoded video bit stream:
determining a bit budget for at least one spatial dependence layer within the access unit; and
calculating at least one initial QP value for encoding the at least one spatial dependence layer based at least partly on the determined bit budget for the at least one spatial dependence layer,
wherein the method further comprising, during encoding of the access unit:
calculating at least one revised QP value for encoding the at least one spatial dependence layer based at least partly on intra layer distortion.

17. The method of claim 2 wherein the method further comprises collecting at least one from a group of bit usage data and distortion data, and using such collected data to update at least one from a group of:
at least one R-Q (Rate-Quantization) model used for calculating QP values; and
at least one distortion prediction model used for estimating inter/intra layer distortion.

18. The method of claim 3 wherein the method further comprises collecting at least one from a group of bit usage data and distortion data, and using such collected data to update at least one from a group of:
at least one R-Q (Rate-Quantization) model used for calculating QP values; and
at least one distortion prediction model used for estimating inter/intra layer distortion.

19. The method of claim 4 wherein the method further comprises collecting at least one from a group of bit usage data and distortion data, and using such collected data to update at least one from a group of:
at least one R-Q (Rate-Quantization) model used for calculating QP values; and
at least one distortion prediction model used for estimating inter/intra layer distortion.

20. The method of claim 5 wherein the method further comprises collecting at least one from a group of bit usage data and distortion data, and using such collected data to update at least one from a group of:
at least one R-Q (Rate-Quantization) model used for calculating QP values; and
at least one distortion prediction model used for estimating inter/intra layer distortion.
